(19) United States
(12) Patent Application Publication
(10) Pub. No.: US 2025/0292366 A1
(43) Pub. Date: Sep. 18, 2025

(54) NEURO-TEMPLATE BASED METHOD AND SYSTEM FOR IMAGE CORRECTION

(71) Applicant: SAMSUNG ELECTRONICS CO., LTD., Suwon-si (KR)

(72) Inventors: Biplab Ch DAS, Bangalore (IN); Shouvik Das, Bangalore (IN); Patel Deval Nileshkumar, Bangalore (IN); Josyula Venkat Narasimham, Bangalore (IN); Kiran Nanjunda Iyer, Bangalore (IN)

(73) Assignee: SAMSUNG ELECTRONICS CO., LTD., Suwon-si (KR)

(21) Appl. No.: 18/781,432

(22) Filed: Jul. 23, 2024

Related U.S. Application Data
(63) Continuation of application No. PCT/KR2024/009794, filed on Jul. 9, 2024.

(30) Foreign Application Priority Data
Mar. 12, 2024 (IN) 202441017810

(51) Int. Cl. G06T 5/50; G06T 5/90

(52) U.S. Cl. CPC G06T 5/50; G06T 5/90; G06T 2207/20084

(57) ABSTRACT

A device and method for performing image correction may include: receiving an input image to be corrected; generating a plurality of template images based on the input image, wherein each template image from among the plurality of template images is generated based on at least one of an image feature transformation; providing the plurality of template images to an artificial intelligence (AI) module; assigning, using the AI module, weights from among zero and non-zero magnitudes to each template image based on an extent and a type of correction to be applied to each template image; and applying the assigned weights to the plurality of template images to obtain a corrected output image.

### CROSS-REFERENCE TO RELATED APPLICATIONS

This application is a continuation of International Application No. PCT/KR2024/009794, filed on Jul. 9, 2024, in the Korean Intellectual Property Receiving Office, which is based on and claims priority to Indian Patent Application No. 202441017810, filed on Mar. 12, 2024, in the Indian Patent Office, the disclosures of which are incorporated by reference herein in their entireties.

### BACKGROUND

### 1. Field

The disclosure relates to image processing, and more particularly to a neuro-template based method and system for image correction.

### 2. Description of Related Art

Automatic white balancing (AWB) techniques may include setting a white point of an image to match a color temperature of ambient light illuminating the scene included in the image without receiving input from the user, so that an appearance of the resulting image matches an appearance of the scene. Some AWB techniques may involve scene illuminant estimation and color balance correction of the image. Automatic exposure techniques may include performing automatic adjustments of the image brightness according to an amount of light that reaches the camera sensor.

Some approaches to AWB may relate to computing a set of transformations from an input image. Then, nearest neighbor matching may be performed on each pixel to perform AWB in the input image. However, the nearest neighbor matching approach may be time consuming when the number of neighboring pixels is relatively large, thereby slowing down the process of AWB. Further, the computations included in the nearest neighbor matching approach may require a large number of training images, which may lead to an increased memory requirement. Therefore, t these approaches to AWB may not be scalable.

Further, some approaches to AWB may consider each pixel in the image independently, and the output of each template may only be dependent on intensities of values across the channels for the same pixel. In addition, some approaches to AWB may not use attribute information such as race or hair texture of person included in the image, or attributes of background categories such as green grass or brown grass, which may be an important clue when performing AWB.

Accordingly, there exists a need for a method and a system which overcomes these problems by providing a memory efficient and a time efficient method and system for image correction.

The information above is only intended to enhance understanding of the general background of the disclosure, and is not intended as an acknowledgement or any form of suggestion that this information is prior art already known to a person skilled in the art.

### SUMMARY

In accordance with an aspect of the disclosure, a method for performing image correction is provided. The method may include receiving an input image to be corrected. The method may include generating a plurality of template images based on the input image, wherein each template image from among the plurality of template images is generated based on at least one of an image feature transformation. The method may include providing the plurality of template images to an artificial intelligence (AI) module. The method may include assigning, using the AI module, weights from among zero and non-zero magnitudes to each template image based on an extent and a type of correction to be applied to each template image. The method may include applying the assigned weights to the plurality of template images to obtain a corrected output image.

In accordance with an aspect of the disclosure, a device for performing image correction is provided. The device may include at least one processor. The device may include a memory configured to store instructions which, when executed by the at least one processor, cause the device to receive an input image to be corrected. The at least one processor may cause the device to generate a plurality of template images based on the input image, wherein each template image from among the plurality of template images is generated based on at least one of an image feature transformation. The at least one processor may cause the device to provide the plurality of template images to an artificial intelligence (AI) module. The at least one processor may cause the device to assign, using the AI module, weights from among zero and non-zero magnitudes to each template image based on an extent and a type of correction to be applied to each template image. The at least one processor may cause the device to apply the assigned weights to the plurality of template images to obtain a corrected output image.

In accordance with an aspect of the disclosure, one or more non-transitory computer-readable storage media storing instructions, wherein the instructions, when executed by at least one processor of a device, cause the device to perform operations are provided. The operations may include receiving an input image to be corrected. The operations may include generating a plurality of template images based on the input image, wherein each template image from among the plurality of template images is generated based on at least one of an image feature transformation. The operations may include providing the plurality of template images to an artificial intelligence (AI) module. The operations may include assigning, using the AI module, weights from among zero and non-zero magnitudes to each template image based on an extent and a type of correction to be applied to each template image. The operations may include applying the assigned weights to the plurality of template images to obtain a corrected output image.

In accordance with an aspect of the disclosure, a computer-readable storage medium storing instructions is provided. The instructions, when executed by at least one processor, may cause the at least one processor to perform the method corresponding.

The foregoing summary is illustrative only and is not intended to be in any way limiting. In addition to the illustrative aspects, embodiments, and features described above, further aspects, embodiments, and features will become apparent by reference to the drawings and the following detailed description.

### BRIEF DESCRIPTION OF THE DRAWINGS

The above and other aspects, features, and advantages of certain embodiments of the present disclosure will be more apparent from the following description taken in conjunction with the accompanying drawings, in which:

FIG. 1 illustrates an environment for image correction, in accordance with an embodiment of the disclosure;

FIG. 2 illustrates a block diagram of data flow for image correction, in accordance with an embodiment of the disclosure;

FIG. 3A illustrates template image generation based on color kernel transform, in accordance with an embodiment of the disclosure;

FIG. 3B illustrates template image generation based on attribute kernel transform, in accordance with an embodiment of the disclosure;

FIG. 3C illustrates template image generation based on shifted pixel kernel transform, in accordance with an embodiment of the disclosure;

FIG. 4 illustrates a training environment for training of AI Model/neural network, in accordance with an embodiment of the disclosure;

FIG. 5 illustrates image correction based on trained AI Model/neural network, in accordance with an embodiment of the disclosure;

FIG. 6 illustrates a block diagram of a system for image correction, in accordance with an embodiment of the disclosure; and

FIG. 7 illustrates a flowchart of a method for image correction, in accordance with an embodiment of the disclosure.

It will be appreciated by those skilled in the art that any block diagrams herein represent conceptual views of illustrative systems embodying the principles of the present subject matter. Similarly, it will be appreciated that any flow charts, flow diagrams, state transition diagrams, pseudo code, and the like represent various processes which may be substantially represented in computer readable medium and executed by a computer or processor, whether or not such computer or processor is explicitly shown.

### DETAILED DESCRIPTION

In the disclosure, the word “exemplary” is intended to mean “serving as an example, instance, or illustration”. Any embodiment or implementation of the present subject matter described herein as “exemplary” is not necessarily to be construed as preferred or advantageous over other embodiments.

Although specific embodiments of the disclosure are described herein and shown by way of example in the drawings, the disclosure is not intended to be limited to the particular forms disclosed, but is instead intended to cover a plurality of modifications, equivalents, and alternatives falling within the spirit and the scope of the disclosure.

The terms “comprises”, “comprising”, or any other variations thereof, are intended to cover a non-exclusive inclusion, such that a setup, device, or method that comprises a list of components or steps does not include only those components or steps but may include other components or steps not expressly listed or inherent to such setup or device or method. In other words, one or more elements in a device or system or apparatus proceeded by “comprises . . . a” does not, without more constraints, preclude the existence of other elements or additional elements in the device or system or apparatus.

In the following detailed description of an embodiment of the disclosure, reference is made to the accompanying drawings that form a part hereof, and in which are shown by way of illustration an embodiment in which the disclosure may be practiced. An embodiment is described in sufficient detail to enable those skilled in the art to practice the disclosure, and it is to be understood that other embodiments may be utilized and that changes may be made without departing from the scope of the disclosure. The following description is, therefore, not to be taken in a limiting sense.

It should be appreciated that the blocks in each flowchart and combinations of the flowcharts may be performed by one or more computer programs which include instructions. The entirety of the one or more computer programs may be stored in a single memory device or the one or more computer programs may be divided with different portions stored in different multiple memory devices.

Any of the functions or operations described herein can be processed by one processor or a combination of processors. The one processor or the combination of processors is circuitry performing processing and includes circuitry like an application processor (AP, e.g. a central processing unit (CPU)), a communication processor (CP, e.g., a modem), a graphics processing unit (GPU), a neural processing unit (NPU) (e.g., an artificial intelligence (AI) chip), a Wi-Fi chip, a Bluetooth® chip, a global positioning system (GPS) chip, a near field communication (NFC) chip, connectivity chips, a sensor controller, a touch controller, a finger-print sensor controller, a display driver integrated circuit (IC), an audio CODEC chip, a universal serial bus (USB) controller, a camera controller, an image processing IC, a microprocessor unit (MPU), a system on chip (SoC), an IC, or the like.

The processor may include various processing circuitry and/or multiple processors. For example, as used herein, including the claims, the term “processor” may include various processing circuitry, including at least one processor, wherein one or more of at least one processor, individually and/or collectively in a distributed manner, may be configured to perform various functions described herein. As used herein, when “a processor”, “at least one processor”, and “one or more processors” are described as being configured to perform numerous functions, these terms cover situations, for example and without limitation, in which one processor performs some of recited functions and another processor(s) performs other of recited functions, and also situations in which a single processor may perform all recited functions. Additionally, the at least one processor may include a combination of processors performing various of the recited/disclosed functions, e.g., in a distributed manner. At least one processor may execute program instructions to achieve or perform various functions.

The terms “artificial intelligence (AI) model” and “neural network” may be used interchangeably throughout the disclosure. According to an embodiment, an AI model and/or neural network may be implemented using an AI module. The AI module may be, or may include, a combination of hardware module and software module. The hardware module may include circuitry used to perform the functionality discussed in an embodiment described herein.

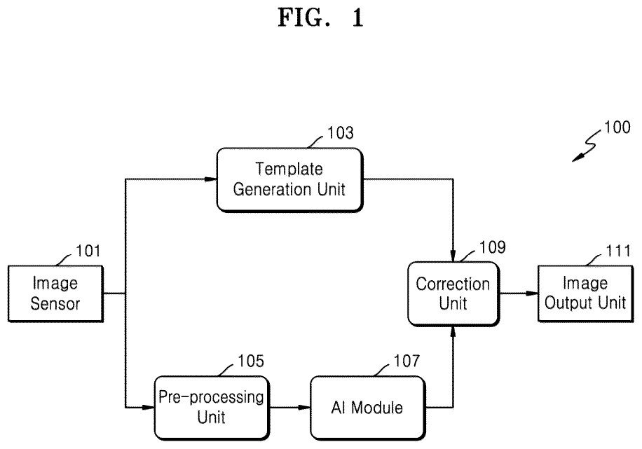

FIG. 1 illustrates an environment 100 for image correction, in accordance with an embodiment of the disclosure.

The environment 100 may include an image sensor 101, a template generation unit 103, a pre-processing unit 105, an AI module 107, a correction unit 109, and an image output unit 111. In an embodiment, the AI module 107 may be or may include, for example, a neural network module. In an embodiment, the AI module 107 may include at least one of an AI model and a neural network.

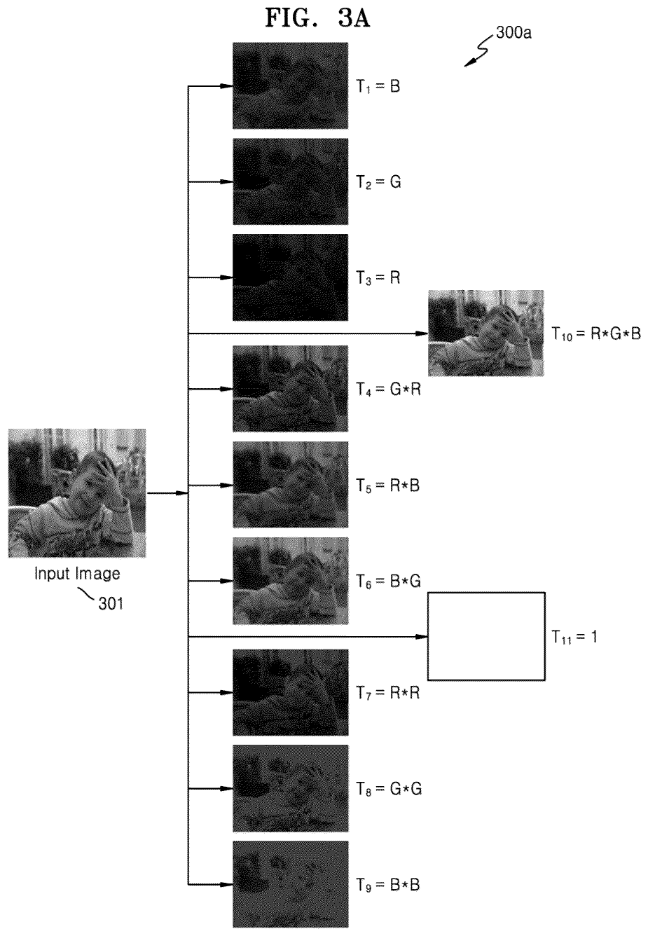

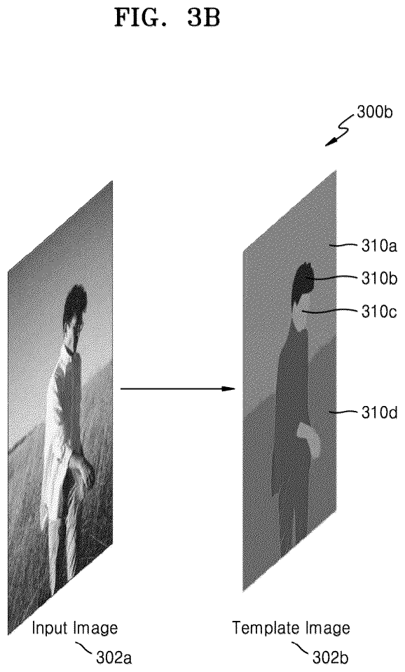

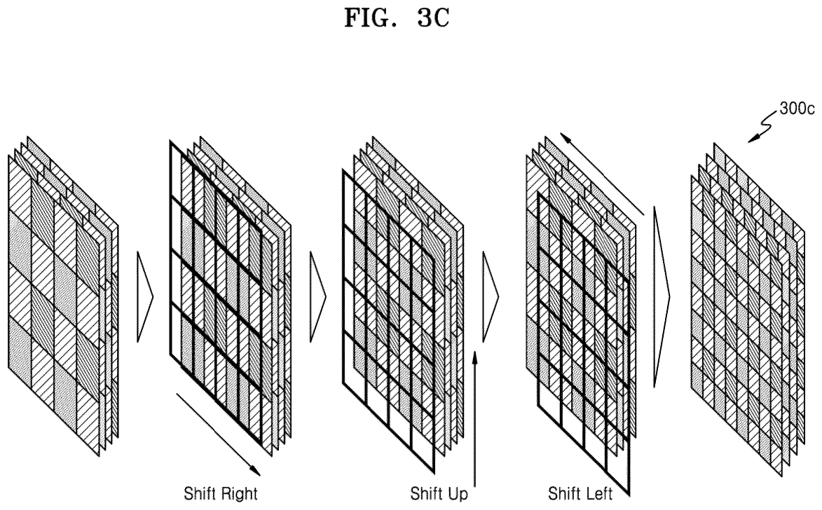

The image sensor 101 may be configured to capture an image. The template generation unit 103 may be configured to apply at least one of an image feature transformation. The image feature transformation may include at least one of a color kernel transform, an attribute kernel transform, and a shifted pixel transform to the captured image to generate a plurality of template images. Examples of the color kernel transform, attribute kernel transform, and shifted pixel transform are discussed in greater detail below with reference to FIGS. 3A-3C.

The pre-processing unit 105 may be configured to carry out preprocessing operations on the captured image for the AI module 107, and send the preprocessed captured image to the AI module 107. The AI module 107 may be configured to estimate correction to be applied to the generated plurality of template images. The correction unit 109 may be configured to apply the estimated corrections to the generated plurality of template images and forward the corrected image to the image output unit 111. The image output unit 111 may be configured to display or otherwise output the corrected image to a user.

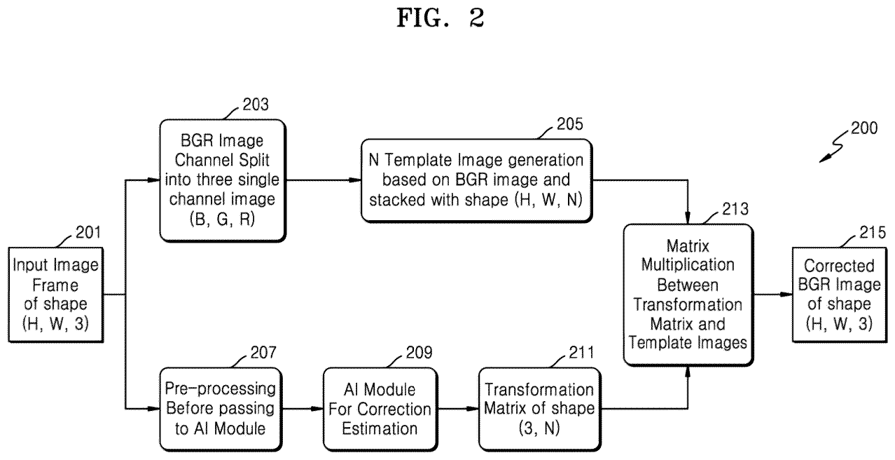

FIG. 2 illustrates a block diagram showing a data flow of a process 200 for performing image correction, in accordance with an embodiment of the disclosure.

At operation 201, the input image may be captured through the image sensor may be input for image correction. The input image frame may be a digital image with values ranging from 0 to 255 and may have a height H, and a width W. The input image frame may be represented using three channel matrices, for example corresponding to a blue color channel B, a green color channel G, and a red color channel R of a blue-green-red (BGR) image. However, an embodiment is not limited thereto, and in an embodiment the input image frame may be represented using three channel matrices corresponding to a red color channel R, a green color channel G, and a blue color channel B of a red-green-blue (RGB) image. The input image frame may be represented as having a shape of (H, W, 3).

At operation 203, BGR image may be split into a three single channel image (e.g., a BGR image). At operation 205, the three channel image may then be used to generate a plurality of template images, which may be stacked with shape H, W, N, where N refers to a number of the template images. At operation 207, the input image may be preprocessed before passing to the AI module 107.

At operation 209, the AI module 107 may carry out correction estimation for each color contribution component of each of the plurality of template images. The correction estimation may be generated in the form of a transformation matrix having a weight for each color contribution component of each of the plurality of template images. At operation 211, the transformation matrix of shape (3, N) may be output through the AI module.

At operation 213, matrix multiplication between the transformation matrix and the template images may be carried out. At operation 215, the corrected BGR image of shape (H, W, 3) may be output to the user. Thus, the image correction carried out using a plurality of template images may facilitate memory efficient and time efficient image correction.

FIG. 3A illustrates template image generation based on a color kernel transform 300a, in accordance with an embodiment of the disclosure.

The color kernel transform may receive an input image 301 including a three channel BGR image of shape (H, W, 3). The color kernel transform may include a template initialization according to Equation 1, Equation 2, and Equation 3 below:

$$B = I [ : , : , 0 ] / 255 \qquad Equation 1$$

$$G = I [ : , : , 1 ] / 255 \qquad Equation 2$$

$$R = I [ : , : , 2 ] / 255 \qquad Equation 3$$

Based on the above initialization, three component images may be generated, which may be scaled by dividing the component images by maximum value of 255. A plurality of template images may be generated based on the component images.

In the example shown FIG. 3A, the plurality of template images may include eleven template images T₁-T₁₁=[Tᵢ]ᵢ₌₁¹¹. The template image may include one or more component images. For example, the eleven template images may be defined according to Equation 4 through Equation 14 below:

$${T}_{1} = B \qquad Equation 4$$

$${T}_{2} = G \qquad Equation 5$$

$${T}_{3} = R \qquad Equation 6$$

$${T}_{4} = G * R \qquad Equation 7$$

$${T}_{5} = R * B \qquad Equation 8$$

$${T}_{6} = B * G \qquad Equation 9$$

$${T}_{7} = R * R \qquad Equation 10$$

$${T}_{8} = G * G \qquad Equation 11$$

$${T}_{9} = B * B \qquad Equation 12$$

$${T}_{10} = R * G * B \qquad Equation 13$$

$${T}_{11} = 1 \qquad Equation 14$$

However, the number of template images is not limited to eleven, and may be increased or decreased to improve the efficiency of image correction. In an embodiment, the number of template images equal to eleven may facilitate best image correction.

In FIG. 3A, the template images are represented as a BGR matrix in color format. However, embodiments are not limited thereto, and during calculation, the template images may be flattened in array format with values scaled between 0 to 1 for normalization purpose.

FIG. 3B illustrates template image generation based on an attribute kernel transform 300b, in accordance with an embodiment of the disclosure. In an embodiment of the disclosure, the semantic details may be extracted using a semantic model. In an embodiment, the semantic model may be at least one of a pretrained machine learning (ML) model, a pretrained AI model, and a pretrained neural network. The extracted semantic details may be used to generate one or more template images.

As shown in FIG. 3B, the input image 302a may be provided to the semantic model, which may be trained for attribute prediction. The semantic model may understand semantic segmentation regions along with the attribute information (e.g., sky-clear, cloudy/hair-black/face-Asian/grass-brown). For example, the sematic model may identify attributes corresponding to sky 310a, hair 310b, face 310c, and grass 310d in the input image 302a, and the template image 302b may be generated based on the identified attributes.

FIG. 3C illustrates template image generation based on a shifted pixel kernel transform 300c, in accordance with an embodiment of the disclosure. In an embodiment, template images may be generated by applying a shifted pixel kernel transform. The pixel shift operation may be used to shift the pixels in a rightward direction, in an upward direction, and in a leftward direction. The pixel shift operation may stack the pixels together to obtain neighborhood pixel information in the template image generation. Each channel of the template image may have pixel values corresponding to a pixel and four neighboring pixels. The template image may include information about spatial association as well as association of different channels, which may be used for correction.

In an embodiment, a plurality of template images may be generated based on at least one of an image feature transformation. The image feature transformation may include at least one of the color kernel transform, the attribute kernel transform, and the shifted pixel kernel transform. In an embodiment, the combination of color kernel transform and attribute kernel transform may be used to generate a plurality of template images. In an embodiment, the combination of color kernel transform and shifted pixel kernel transform may be used to generate a plurality of template images. In an embodiment, the combination of color kernel transform, attribute kernel transform, and shifted pixel kernel transform may be used to generate a plurality of template images.

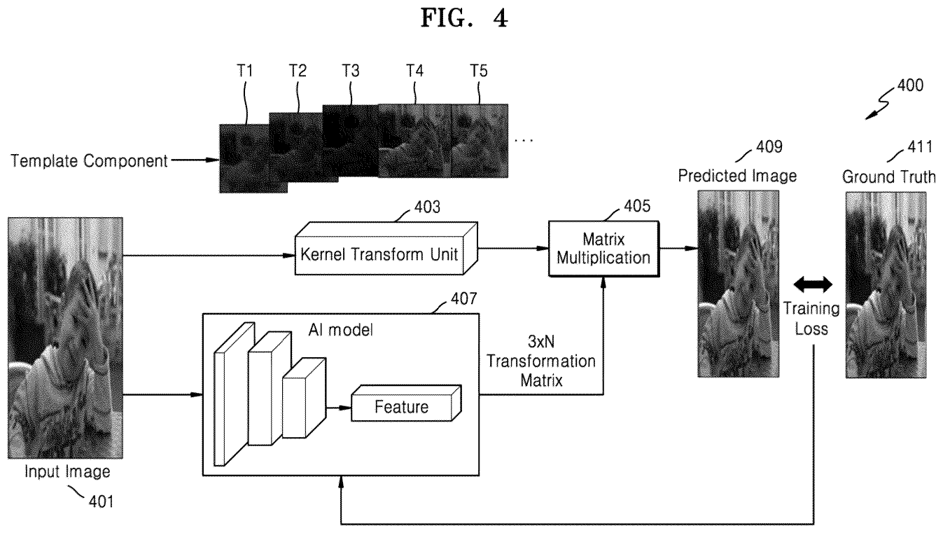

FIG. 4 illustrates a training environment 400 for training at least one of an AI model and a neural network, in accordance with an embodiment of the disclosure.

In an embodiment of the disclosure, the training environment 400 may include an AI model 407 to be trained for generation of accurate image correction parameters. In an embodiment, the AI model 407 may be, or may include, a neural network, but embodiments are not limited thereto. An input image 401 may be provided in parallel to the AI model 407 and to a kernel transform unit 403. In an embodiment, the AI model 407 may correspond to the AI module 107, and the kernel transform unit 403 may correspond to the template generation unit 103, but embodiments are not limited thereto. In an embodiment, the kernel transform unit 403 may apply a color kernel transform and may generate plurality of templates images having different combinations of three color channels (e.g., B, G, and R as shown in FIG. 4). For example, the kernel transform unit 403 may output a template image T₁ corresponding to a blue color channel B, a template image T₂ corresponding to a green color channel G, a template image T₃ corresponding to a red color channel R, a template image T₄ corresponding to a combination of the green color channel G and the red color channel R, and a template image Ty corresponding to a combination of the blue color channel B and the red color channel R, but embodiments are not limited thereto. However, the kernel transform unit 403 is not limited to color kernel transforms, and may include, but is not limited to, one or more of an attribute kernel transform and a shifted pixel kernel transform along with the color kernel transform.

The AI model 407 may be configured to generate features that corresponds to a weight selected from among zero and non-zero magnitudes to each template image based on extent and type of correction required in each template image. In an embodiment, the weights may be assigned in the form of transformation matrix by assigning weight to each color contribution component of each of the plurality of template images.

In an example, the input image may be a three-channel input image and the number of the template images may be N. Therefore, the transformation matrix may have a size of “3×N”. The transformation matrix may be applied to the plurality of template images using matrix multiplication 405. The matrix multiplication 405 may generate a predicted image 409.

In an embodiment, predicted image 409 may be compared with the ground truth image 411, which may be for example an actual image, for loss calculation. The training loss determined by the loss calculation may be used as feedback to the AI model 407. The AI model 407 may be configured to update the previously generated weights/transformation matrix based on the training loss. In an embodiment, the transformation matrix generation, the matrix multiplications, and the loss calculation, may be repeated until the training loss decreases below a training loss threshold. In an embodiment, the transformation matrix generation, the matrix multiplications, and the loss calculation may be repeated to minimize the training loss, or to bring the value of the training loss relatively close to zero.

Therefore, the training of the AI model 407 may not require a large amount of training images to predict the corrected image, thereby reducing the overall memory requirement for training and making the above solution scalable. Further, the training of the AI model 407 may be carried out in a time-efficient manner. In addition, the resources used for the training of the AI model 407 may be reduced, making it feasible to perform the training using devices having limited resources, for example mid-tier and low-tier devices having fewer resources than high-tier devices.

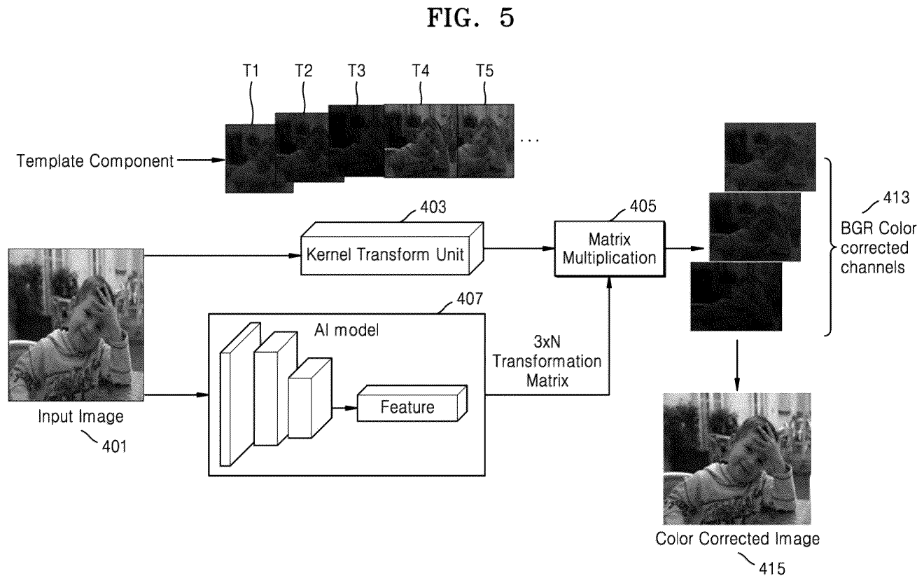

FIG. 5 illustrates image correction based on trained AI model 407, in accordance with an embodiment of the disclosure.

In an embodiment of the disclosure, the input image 401 may be provided to the kernel transform unit 403. The kernel transform unit 403 may be configured to apply one or more of an image feature transformation. The image feature transformation may include at least one of the color kernel transform, the attribute kernel transform, and the shifted pixel kernel transform to generate a plurality of template images as discussed above with reference to FIGS. 3A-3C.

The input image 401 may be provided to the trained AI Model 407. The trained AI Model 407 may be configured to generate or assign weights selected from among zero and non-zero magnitudes to each template image based on an extent and a type of correction required for each template image of the plurality of template images generated by the kernel transform unit 403.

The assigned weights may be provided as a transformation matrix in which a weight is assigned to each color contribution component of each of the plurality of template images. The matrix multiplication 405 may be carried out between the template images and the transformation matrix to generate BGR color corrected channels 413. The BGR color corrected channels 413 may be combined to form a color corrected image 415, which may be for example an image which is properly white-balanced.

In the example shown in FIG. 5, the template images may include a template image T₁ corresponding to a blue color channel B, a template image T₂ corresponding to a green color channel G, a template image T₃ corresponding to a red color channel R, a template image T₄ corresponding to a combination of the green color channel G and the red color channel R, and a template image T₅ corresponding to a combination of the blue color channel B and the red color channel R.

In an embodiment, the AI model 407 may generate a transformation matrix including weight vectors w₁ to w₅ corresponding to the template images T₁ to T₅. In an embodiment, the weight vectors w₁ to w₅ may be expressed according to Equations 15 through 19 below.

A weight vector w₁ corresponding to the template image T₁ may be expressed according to Equation 15, a weight vector w₂ corresponding to the template image T₂ may be expressed according to Equation 16, a weight vector w₃ corresponding to the template image T₃ may be expressed according to Equation 17, a weight vector w₄ corresponding to the template image T₄ may be expressed according to Equation 18, and a weight vector w₅ corresponding to the template image Ty may be expressed according to Equation 19.

$${w}_{1} = [ \begin{matrix}0.55 \\ 0.014 \\ 0.037\end{matrix} ] \qquad Equation 15$$

$${w}_{2} = [ \begin{matrix}- 0.22 \\ 0.936 \\ 0.266\end{matrix} ] \qquad Equation 16$$

$${w}_{3} = [ \begin{matrix}- 0.014 \\ - 0.084 \\ 1.115\end{matrix} ] \qquad Equation 17$$

$${w}_{4} = [ \begin{matrix}- 0.202 \\ 0.292 \\ - 0.218\end{matrix} ] \qquad Equation 18$$

$${w}_{5} = [ \begin{matrix}- 0.039 \\ 0.000 \\ - 0.004\end{matrix} ] \qquad Equation 19$$

As can be seen above, the template image T₁ may correspond to weights w₁ in which 0.55 is the weight contributor to final blue channel, 0.014 is the weight contributor to final green channel, and 0.037 is the weight contributor for the final red channel. The template image T₂ may correspond to weights w₂ in which −0.22 is the weight contributor to final blue channel, 0.936 is the weight contributor to final green channel, and 0.266 is the weight contributor for the final red channel. The template image T₃ may correspond to weights w₃ in which −0.014 is the weight contributor to final blue channel, −0.084 is the weight contributor to final green channel, and 1.115 is the weight contributor for the final red channel. The template image T₄ may correspond to weights w₄ in which −0.202 is the weight contributor to final blue channel, 0.292 is the weight contributor to final green channel, and −0.218 is the weight contributor for the final red channel. The template image T₅ may correspond to weights w₅ in which −0.039 is the weight contributor to final blue channel, 0.000 is the weight contributor to final green channel, and −0.004 is the weight contributor for the final red channel.

The AI Model 407 may be configured to generate weight vectors specifying weight contributors for each channel included in the remaining template images. For example, based on the original image having a bluish tint, a color corrected image may add more of green and red channel components to obtain a color corrected image 415, as shown for example in the bolded values. Therefore, highest value is 1.115 in transformation vector for the template image T₃ contributing to final red color channel R, and second highest is 0.936 in transformation vector for the template image T₂ contributing to final green color channel G, and so on.

In an embodiment, eleven template images may be generated as shown in FIG. 3A and the transformation matrix having a size of ‘3×11’ may be generated for correcting each template image. The matrix multiplication 405 between the eleven template images and transformation matrix having a size of ‘3×11’ may be carried out to apply the correction to each of the template images.

The BGR color corrected channels 413 may be generated as the result of the matrix multiplication 405. The correction weights from the trained AI model 407 may facilitate accurate auto white balance correction to the input image.

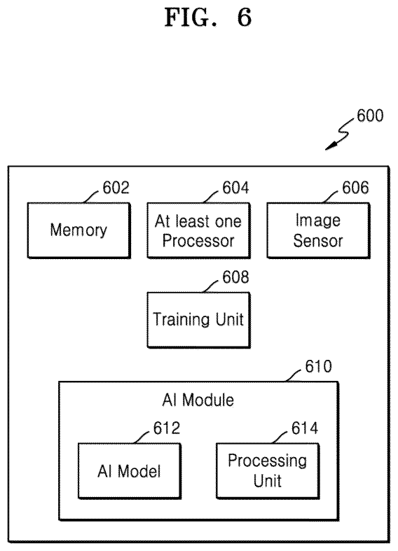

FIG. 6 illustrates a block diagram of a system 600 for image correction, in accordance with an embodiment of the disclosure.

In an embodiment of the disclosure, the system 600 may include a memory 602, at least one processor 604, an image sensor 606, a training unit 608, and an AI module 610 communicatively coupled with each other. The AI module 610 may further include an AI Model 612 and a processing unit 614. In an embodiment, the system 600 may include an input/output (I/O) module and communication interface.

It may be noted that, in an embodiment, the system 600 may include more or fewer components than those depicted herein. The various components of the system 600 may be implemented using hardware, software, firmware or any combinations thereof. Further, the various components of the system 600 may be operably coupled with each other. More specifically, various components of the system 600 may be capable of communicating with each other using communication channel media (such as buses, interconnects, etc.).

In an embodiment, the at least one processor 604 and the processing unit 614 may be, or may include, a multi-core processor, a single core processor, or a combination of one or more multi-core processors and one or more single core processors. For example, the at least one processor 604 and the processing unit 614 may be embodied as one or more of various processing devices, such as a coprocessor, a microprocessor, a controller, a digital signal processor (DSP), a processing circuitry with or without an accompanying DSP, or various other processing devices including, a microcontroller unit (MCU), a hardware accelerator, a special-purpose computer chip, or the like.

In an embodiment, the memory 602 may be capable of storing machine executable instructions, referred to herein as instructions. In an embodiment, the at least one processor 604 and the processing unit 614 are embodied as an executor of software instructions. As such, the at least one processor 604 and the processing unit 614 may be capable of executing the instructions stored in the memory 602 to perform one or more operations described herein.

The memory 602 can be any type of storage accessible to the at least one processor 604 and the processing unit 614 to perform respective functionalities. For example, the memory 602 may include one or more volatile or non-volatile memories, or a combination thereof. For example, the memory 602 may be embodied as semiconductor memories, such as flash memory, mask ROM, PROM (programmable ROM), EPROM (erasable PROM), RAM (random access memory), and the like.

In an embodiment, the AI Model 612 may be configured in the internal memory or storage of the AI module 610 for predicting the correction weights for achieving auto white balance in the image. Some examples of the one or more AI models include, but are not limited to, a neural network, a deep neural network, an ML model, and the like.

In an embodiment of the disclosure, an input image may be received for correction. The correction facilitated by the system 600 may be auto white balance correction. The at least one input image may be captured using at least one image sensor 606. In an embodiment, the input image may be prestored in the memory 602 and may be retrieved from the memory 602 for correction. In an embodiment, the input image may be received from an I/O module of the system 600.

After the image is received for correction, the at least one processor 604 may be configured to generate a plurality of template images. In an embodiment, the at least one processor 604 may be configured to generate each template image of the plurality of template images at least based on a non-linear combination of one or more channels from among RGB channels. The plurality of template images may be generated by applying color kernel transform, as discussed with reference to FIG. 3A.

In an embodiment of the disclosure, to generate the plurality of template images from the input image, the at least one processor 604 may be configured to extract, using the AI module 610, semantic segmentation information included in the input image, and generate one or more template images corresponding to one or more attributes included in the semantic segmentation information. The AI module 610 may be trained based on a plurality of images and their corresponding attributes for understanding the semantic segmentation information included in the image. Each template image generated by the AI module 610 may include at least one attribute. The plurality of template images in an embodiment may be generated by applying attribute kernel transform, as discussed above with reference to FIG. 3B.

In an embodiment of the disclosure, to generate the plurality of template images from the input image, the at least one processor 604 may be configured to generate a plurality of template images by performing pixel shift operations on plurality of pixels present in the input image. The pixel shift operations may include a shift right operation, a shift left operation, a shift up operation and a shift down operation. The plurality of template images in an embodiment may be generated by applying a shifted pixel kernel transform, as discussed with reference to FIG. 3C.

In an embodiment of the disclosure, the at least one processor 604 may be configured to generate a plurality of template images based on application of one or more of an image feature transformation. The image feature transformation may include at least one of the color kernel transform, the attribute kernel transform, and the shifted pixel kernel transform on the input image.

After the plurality of template images are generated, the at least one processor 604 may be configured to assign a weight from among zero and non-zero magnitudes to each template image based on an extent and a type of correction required in each template image. The weights may be assigned by the at least one processor 604 using the AI module 610. To assign the weight from among the zero and non-zero magnitudes to each template image, the at least one processor 604 may be configured to generate a transformation matrix by assigning weights to each color contribution component of each of the plurality of template images. For example, for an RGB image, a weight may be assigned to each color contribution component, as discussed above with reference to FIG. 5.

In an embodiment of the disclosure, the at least one processor 604 may be configured to apply the assigned weights to the plurality of template images to obtain a corrected output image. The application of the assigned weights to the plurality of template images may involve matrix multiplication between plurality of template images and the transformation matrix generated by the AI module, as shown in FIG. 5. The output of the matrix multiplication operation is the corrected output image.

In an embodiment of the disclosure, the at least one processor 604 may be configured to provide a plurality of sample template images corresponding to a sample image to the AI module 610. The AI module 610 may be configured to predict a weight for each color contribution component of each of the plurality of sample template images.

The at least one processor 604 may be configured to apply the predicted weights to each color contribution component of each of the plurality of sample template images to generate a predicted output image. The at least one processor 604 may be configured to compare the predicted output image with ground truth image of the sample image. The at least one processor 604 may be configured to calculate training loss between the predicted output image and ground truth image.

The training unit 608 may be configured to train the AI module 610 based on the calculated training loss, which may be provided as feedback to the AI module 610, as described above with reference to FIG. 4. The training unit 608 may be configured to train the AI module 610 until the training loss is below a predetermined threshold value.

The training of the AI module 610 may involve training the AI model 612 included in the AI module 610. The AI model 612 may include at least one of a neural network, a deep neural network, an ML model, or like.

The training of the AI model 612 may not require a plurality of training images to predict the corrected image, thereby reducing the overall memory requirement for training and making the above solution scalable. The training of the AI model 612 may be carried out in a time efficient manner. The above-solution may be feasible for devices having limited resources, for example mid-tier and low-tier devices having fewer resources than high-tier devices.

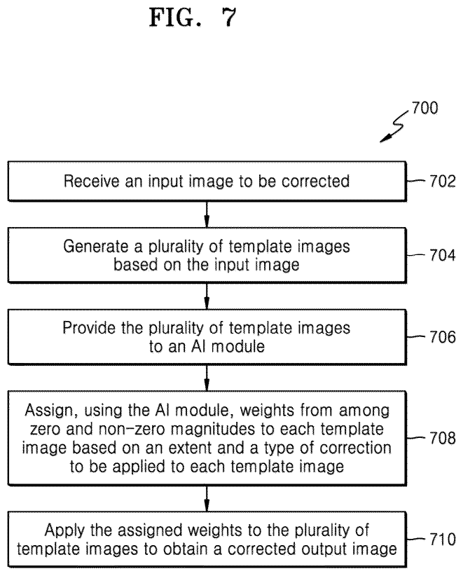

FIG. 7 illustrates a flowchart of a method 700 for image correction, in accordance with an embodiment of the disclosure. The method 700 depicted in the flow diagram may be executed by, for example, the system 600. Operations of the flow diagram, and combinations of operations in the flow diagram, may be implemented by, for example, hardware, firmware, a processor, circuitry and/or a different device associated with the execution of software that includes one or more computer program instructions.

The operations of the method 700 may be described and/or practiced by using at least one processor 604 of a system or device other than the system 600, for example, an image processing system.

At operation 702, the method 700 may include receiving an input image for correction. The at least one input image may be captured using at least one image sensor. In an embodiment, the input image may be prestored in the memory and may be retrieved from the memory for correction. In an embodiment, the input image may be received from an external source through I/O module.

At operation 704, the method 700 may include generating a plurality of template images. In an embodiment, the generating may include generating each template image of the plurality of template images at least based on a non-linear combination of one or more channels from among RGB channels. The plurality of template images may be generated by applying color kernel transform, as discussed above with reference to FIG. 3A.

In an embodiment of the disclosure, the generating the plurality of template images based on the input image may include extracting, using the AI module, semantic segmentation information present in the input image and generating one or more template images corresponding to one or more attributes included in in the semantic segmentation information. The AI module may be trained based on a plurality of images and their corresponding attributes for understanding the semantic segmentation information included in the image. Each template image generated by the AI module may include at least one attribute. The plurality of template images in an embodiment may be generated by applying an attribute kernel transform, as discussed above with reference to FIG. 3B.

In an embodiment of the disclosure, the generating the plurality of template images based on the input image may include generating a plurality of template images by performing pixel shift operations on plurality of pixels present in the input image. The pixel shift operations may include a shift right operation, a shift left operation, a shift up operation, and a shift down operation. The plurality of template images in an embodiment may be generated by applying shifted pixel kernel transform, as discussed above with reference to FIG. 3C.

In an embodiment of the disclosure, the generating the plurality of template images based on the input image may include generating a plurality of template images based on application of one or more of an image feature transformation. The image feature transformation may include at least one of the color kernel transform, the attribute kernel transform, and the shifted pixel kernel transform on the input image.

At operation 706, the method 700 may include providing the plurality of template images to an AI module. At operation 708, the method 700 may include assigning a weight from among zero and non-zero magnitudes to each template image based on extent and type of correction required for each template image. The weights may be assigned using the AI module 610. The assigning the weight from among zero and non-zero magnitudes to each template image may include generating a transformation matrix by assigning weights to each color contribution component of each of the plurality of template images. For example, for an RGB image, the weight may be assigned to each color contribution component, as discussed above with reference to FIG. 5.

At operation 710, the method 700 may include applying the assigned weights to the plurality of template images to obtain a corrected output image. The application of the assigned weights to the plurality of template images may involve matrix multiplication between plurality of template images and the transformation matrix generated by the AI module, as shown in FIG. 5. The output of the matrix multiplication operation may be the corrected output image.

In an embodiment of the disclosure, the method 700 may include a method for training the AI module. The method 700 may include providing a sample image to the AI module for training. The method 700 may then include predicting, using the AI module, a weight for each color contribution component of each of the plurality of sample template images.

The method 700 may include applying the predicted weights to each color contribution component of each of the plurality of sample template images to generate a predicted output image. The method 700 may include comparing the predicted output image with ground truth image of the sample image. The method 700 may include calculating training loss between the predicted output image and ground truth image.

The method 700 may include training the AI module based on the calculated training loss, which may be provided as feedback to the AI module, as described above with reference to FIG. 4. The training of the AI module may be performed until the training loss is below a predetermined threshold value.

The training of the AI module may not require a plurality of training images to predict the corrected image, thereby reducing the overall memory requirement for training and making the above solution scalable. The above-solution may feasible for devices having limited resources, for example mid-tier and low-tier devices having fewer resources than high-tier devices.

The sequence of operations of the method 700 may be executed in an order different from the order presented in FIG. 7. Further, one or more operations may be grouped together and performed in form of a single step, or one operation may have several sub-steps that may be performed in parallel or in sequential manner.

The disclosed method with reference to FIG. 7, or one or more operations of the system 600 explained with reference to FIG. 7 and may be implemented using software including computer-executable instructions stored on one or more computer-readable media (e.g., non-transitory computer-readable media, such as one or more optical media discs), volatile memory components (e.g., DRAM or SRAM), or non-volatile memory or storage components (e.g., hard drives or solid-state non-volatile memory components, such as Flash memory components) and executed on a computer (e.g., any suitable computer, such as a laptop computer, net book, Web book, tablet computing device, smart phone, or other mobile computing device). Such software may be executed, for example, on a single local computer.

Furthermore, one or more computer-readable storage media may be utilized in implementing an embodiment consistent with the disclosure. A computer-readable storage medium refers to any type of physical memory on which information or data readable by a processor may be stored. Thus, a computer-readable storage medium may store instructions for execution by one or more processors, including instructions for causing the processor(s) to perform steps or stages consistent with an embodiment described herein. The term “computer-readable medium” may be understood to include tangible items and exclude carrier waves and transient signals, e.g., be non-transitory. Examples include Random Access Memory (RAM), Read-Only Memory (ROM), volatile memory, non-volatile memory, hard drives, CD (Compact Disc) ROMs, DVDs, flash drives, disks, and any other known physical storage media.

It will be understood by those within the art that, in general, terms used herein, and are generally intended as “open” terms (e.g., the term “including” may be interpreted as “including but not limited to,” the term “having” may be interpreted as “having at least,” the term “includes” may be interpreted as “includes but is not limited to,” etc.). For example, as an aid to understanding, the detail description may contain usage of the introductory phrases “at least one” and “one or more” to introduce recitations. However, the use of such phrases may not be construed to imply that the introduction of a recitation by the indefinite articles “a” or “an” limits any particular part of description containing such introduced recitation to disclosure containing only one such recitation, even when the introductory phrases “one or more” or “at least one” and indefinite articles such as “a” or “an” (e.g., “a” and/or “an” may typically be interpreted to mean “at least one” or “one or more”) are included in the recitations; the same holds true for the use of definite articles used to introduce such recitations. In addition, even if a specific part of the introduced description recitation is explicitly recited, those skilled in the art will recognize that such recitation may typically be interpreted to mean at least the recited number (e.g., the bare recitation of “two recitations,” without other modifiers, typically means at least two recitations or two or more recitations).

As used here, terms and phrases such as “have”, “may have”, “include”, or “may include” a feature (like a number, function, operation, or component such as a part) indicate the existence of the feature and do not exclude the existence of other features. Also, as used here, the phrases “A or B”, “at least one of A and/or B”, or “one or more of A and/or B” may include all possible combinations of A and B. For example, “A or B”, “at least one of A and B”, and “at least one of A or B” may indicate all of (1) including at least one A, (2) including at least one B, or (3) including at least one A and at least one B.

While various aspects and embodiments have been disclosed herein, other aspects and embodiments will be apparent to those skilled in the art. The various aspects and embodiments disclosed herein are for purposes of illustration and are not intended to limit the scope and spirit of the disclosure.

In an embodiment, the method, wherein the assigning of the weights may include generating a transformation matrix by assigning a weight to each color contribution component of each template image from among the plurality of template images.

In an embodiment, the method, wherein the applying of the assigned weights may include performing a matrix multiplication between the transformation matrix and the plurality of template images.

In an embodiment, the method, wherein the generating of the plurality of template images may include generating each template image from among the plurality of template images based on at least a non-linear combination of one or more channels from among red-green-blue (RGB) color channels.

In an embodiment, the method, wherein the generating of the plurality of template images may include extracting, using the AI module, semantic segmentation information included in the input image. The method, wherein the generating of the plurality of template images may include generating one or more template images corresponding to one or more attributes included in the semantic segmentation information, wherein each template image from among the one or more template images may include at least one attribute.

In an embodiment, the method, wherein the generating of the plurality of template images may include generating the plurality of template images by performing at least one pixel shift operation on a plurality of pixels included in the input image, wherein the at least one pixel shift operation may include at least one from among a shift right operation, a shift left operation, a shift up operation, and a shift down operation.

In an embodiment, the method, wherein the image feature transformation may include at least one of a color kernel transform, an attribute kernel transform, and a shifted pixel kernel transform.

In an embodiment, the method may include providing, to the AI module, a plurality of sample template images corresponding to a sample image. The method may include generating predicted weights for color contribution components corresponding to the plurality of sample template images. The method may include applying the predicted weights to the color contribution components corresponding to the plurality of sample template images to generate a predicted output image. The method may include comparing the predicted output image with a ground truth image to calculate a training loss. The method may include training the AI module based on the calculated training loss.

In an embodiment, the method, wherein the training of the AI module may include performing a loss calculation until the training loss is below a predetermined threshold value.

In an embodiment, the device, wherein to assign the weights, the instructions may cause the device to generate a transformation matrix by assigning a weight to each color contribution component of each template image from among the plurality of template images.

In an embodiment, the device, wherein to apply the assigned weights, the instructions may cause the device to perform a matrix multiplication between the transformation matrix and the plurality of template images.

In an embodiment, the device, wherein to generate the plurality of template images, the instructions may cause the device to generate each template image from among the plurality of template images based on at least a non-linear combination of one or more channels from among red-green-blue (RGB) color channels.

In an embodiment, the device, wherein to generate the plurality of template images, the instructions may cause the device to extract, using the AI module, semantic segmentation information included in the input image. The device, wherein to generate the plurality of template images, the instructions may cause the device to generate one or more template images corresponding to one or more attributes included in the semantic segmentation information, wherein each template image from among the one or more template images may include at least one attribute.

In an embodiment, the device, wherein to generate the plurality of template images, the instructions may cause the device to generate the plurality of template images by performing at least one pixel shift operation on a plurality of pixels included in the input image, wherein the at least one pixel shift operation may include at least one from among a shift right operation, a shift left operation, a shift up operation and a shift down operation.

In an embodiment, the device, wherein the image feature transformation may include at least one of a color kernel transform, an attribute kernel transform, and a shifted pixel kernel transform.

In an embodiment, the device, wherein the instructions may cause the device to provide, to the AI module, a plurality of sample template images corresponding to a sample image. The device, wherein the instructions may cause the device to generate predicted weights for color contribution components corresponding to the plurality of sample template images. The device, wherein the instructions may cause the device to apply the predicted weights to the color contribution components corresponding to the plurality of sample template images to generate a predicted output image. The device, wherein the instructions may cause the device to compare the predicted output image with a ground truth image to calculate a training loss. The device, wherein the instructions may cause the device to train the AI module based on the calculated training loss.

In an embodiment, the device, wherein to train the AI module, the instructions may cause the device to perform a loss calculation until the training loss is below a predetermined threshold value.

In an embodiment, the one or more non-transitory computer-readable storage media, wherein the generating of the plurality of template images may include generating each template image from among the plurality of template images based on at least a non-linear combination of one or more channels from among red-green-blue (RGB) color channels.

We claim:

1. A method for performing image correction, the method comprising:
receiving an input image to be corrected;
generating a plurality of template images based on the input image, wherein each template image from among the plurality of template images is generated based on at least one of an image feature transformation;
providing the plurality of template images to an artificial intelligence (AI) module;
assigning, using the AI module, weights from among zero and non-zero magnitudes to each template image based on an extent and a type of correction to be applied to each template image; and
applying the assigned weights to the plurality of template images to obtain a corrected output image.

2. The method as claimed in claim 1, wherein the assigning of the weights comprises:
generating a transformation matrix by assigning a weight to each color contribution component of each template image from among the plurality of template images.

3. The method as claimed in claim 2, wherein the applying of the assigned weights comprises:
performing a matrix multiplication between the transformation matrix and the plurality of template images.

4. The method as claimed in claim 1, wherein the generating of the plurality of template images comprises:
generating each template image from among the plurality of template images based on at least a non-linear combination of one or more channels from among red-green-blue (RGB) color channels.

5. The method as claimed in claim 1, wherein the generating of the plurality of template images comprises:
extracting, using the AI module, semantic segmentation information included in the input image; and
generating one or more template images corresponding to one or more attributes included in the semantic segmentation information,
wherein each template image from among the one or more template images comprises at least one attribute.

6. The method as claimed in claim 1, wherein the generating of the plurality of template images comprises:
generating the plurality of template images by performing at least one pixel shift operation on a plurality of pixels included in the input image,
wherein the at least one pixel shift operation comprises at least one from among a shift right operation, a shift left operation, a shift up operation, and a shift down operation.

7. The method as claimed in claim 1, wherein the image feature transformation comprises at least one of a color kernel transform, an attribute kernel transform, and a shifted pixel kernel transform.

8. The method as claimed in claim 1, further comprising:
providing, to the AI module, a plurality of sample template images corresponding to a sample image;
generating predicted weights for color contribution components corresponding to the plurality of sample template images;
applying the predicted weights to the color contribution components corresponding to the plurality of sample template images to generate a predicted output image;
comparing the predicted output image with a ground truth image to calculate a training loss; and
training the AI module based on the calculated training loss.

9. The method as claimed in claim 8, wherein the training of the AI module comprises:
performing a loss calculation until the training loss is below a predetermined threshold value.

10. A device for performing image correction, the device comprising:
at least one processor; and
a memory configured to store instructions which, when executed by the at least one processor, cause the device to:
receive an input image to be corrected;
generate a plurality of template images based on the input image, wherein each template image from among the plurality of template images is generated based on at least one of an image feature transformation;
provide the plurality of template images to an artificial intelligence (AI) module;
assign, using the AI module, weights from among zero and non-zero magnitudes to each template image based on an extent and a type of correction to be applied to each template image; and
apply the assigned weights to the plurality of template images to obtain a corrected output image.

11. The device as claimed in claim 10, wherein to assign the weights, the instructions further cause the device to:
generate a transformation matrix by assigning a weight to each color contribution component of each template image from among the plurality of template images.

12. The device as claimed in claim 11, wherein to apply the assigned weights, the instructions further cause the device to:
perform a matrix multiplication between the transformation matrix and the plurality of template images.

13. The device as claimed in claim 10, wherein to generate the plurality of template images, the instructions further cause the device to:
generate each template image from among the plurality of template images based on at least a non-linear combination of one or more channels from among red-green-blue (RGB) color channels.

14. The device as claimed in claim 10, wherein to generate the plurality of template images, the instructions further cause the device to:
extract, using the AI module, semantic segmentation information included in the input image; and
generate one or more template images corresponding to one or more attributes included in the semantic segmentation information,
wherein each template image from among the one or more template images comprises at least one attribute.

15. The device as claimed in claim 10, wherein to generate the plurality of template images, the instructions further cause the device to:
generate the plurality of template images by performing at least one pixel shift operation on a plurality of pixels included in the input image,
wherein the at least one pixel shift operation comprises at least one from among a shift right operation, a shift left operation, a shift up operation, and a shift down operation.

16. The device as claimed in claim 10, wherein the image feature transformation comprises at least one of a color kernel transform, an attribute kernel transform, and a shifted pixel kernel transform.

17. The device as claimed in claim 10, wherein the instructions further cause the device to:
provide, to the AI module, a plurality of sample template images corresponding to a sample image;
generate predicted weights for color contribution components corresponding to the plurality of sample template images;
apply the predicted weights to the color contribution components corresponding to the plurality of sample template images to generate a predicted output image;
compare the predicted output image with a ground truth image to calculate a training loss; and
train the AI module based on the calculated training loss.

18. The device as claimed in claim 17, wherein to train the AI module, the instructions further cause the device to:
perform a loss calculation until the training loss is below a predetermined threshold value.

19. One or more non-transitory computer-readable storage media storing instructions, wherein the instructions, when executed by at least one processor of a device, cause the device to perform operations, the operations comprising:
receiving an input image to be corrected;
generating a plurality of template images based on the input image, wherein each template image from among the plurality of template images is generated based on at least one of an image feature transformation;
providing the plurality of template images to an artificial intelligence (AI) module;
assigning, using the AI module, weights from among zero and non-zero magnitudes to each template image based on an extent and a type of correction to be applied to each template image; and
applying the assigned weights to the plurality of template images to obtain a corrected output image.

20. The one or more non-transitory computer-readable storage media of claim 19, wherein the generating of the plurality of template images comprises:
generating each template image from among the plurality of template images based on at least a non-linear combination of one or more channels from among red-green-blue (RGB) color channels.
